(19) United States
(12) Patent Application Publication
(10) Pub. No.: US 2002/0110349 A1
(43) Pub. Date: Aug. 15, 2002

(54) Minuscule images of alphanumeric symbols

(76) Inventor: Joseph D. Udy, Aurora, CO (US)

Correspondence Address: Joseph D. Udy, Apt. # 362, 4466 S. Helena Way, Aurora, CO, 80015-4415, US

(21) Appl. No.: 09/784,773

(22) Filed: Feb. 15, 2001

(51) Int. Cl. G02B 6/00; G09F 19/00

(52) U.S. Cl. 385/147; 40/541

(57) ABSTRACT

A laser light pulse is used to create a minuscule image of an alphanumeric symbol.

### BACKGROUND-FIELD OF INVENTION

This invention relates to switchs and to the use of alphanumeric symbols on MicroElectroMechanical System, MEMS, mirrors.

### BACKGROUND-PRIOR ART

The use of binary switchs and the resulting binary code have required that relatively long code strings be used to represent or transmit simple symbols.

### OBJECTIVE AND ADVANTAGES

Alphanumeric symbols on the mirrors of MEMS switchs allow the representation and/or transmission of symbol images with very short pulses of laser light.

### SUMMARY

Minuscule images, of alphanumeric symbols formed on MEMS mirrors, are created for use in optronic/photonic devices and systems.

### DESCRIPTION

Nonreflective alphanumeric symbols are etched or formed onto the mirrors of MEMS switchs.

### OPERATION

A light pulse reflected from a marked mirror would form an image of the symbol on that mirror. The light pulse image could be directed into an optical fiber for transmission. Projection of the light pulse image onto a CCD chip (or screen) would provide readout. Storage might be projection of the symbol image directly onto a CD (or with light stopping methods of Rowland Institute).

### CONCLUSIONS, RAMIFICATIONS AND SCOPE

The limiting factor may be the number of photons necessary to form an image. Many paths toward that limit appear possible: for example, extremely small symbols, extremely short light pulses, multiple symbols on each mirror, lens systems, very high element number switchs; i.e. current MEMS switchs have 256 mirrors (possible symbols), frequency multiplexing; i.e. each frequency of the light pulse forming an image, and reflective symbols on a nonreflective background. Alternatively: symbols might be formed directly onto the exit mirrors of lasers such that the laser pulse, itself, is the image; or images created by passing the light pulse through an image medium. Eventually, a image may be worth a thousand bits.

1. Means to create minuscule images.

2. The images of claim 1 wherein alphanumeric images are created.

3. The image creation of claim 1 wherein images are created by reflection.

4. the image creation of claim 1 wherein images are created by/in the light pulse.
